(19) United States
(12) Patent Application Publication
(10) Pub. No.: US 2006/0196368 A1
(43) Pub. Date: Sep. 7, 2006

(54) Smoking Apparatus

(76) Inventor: Dave Whitmer, Oxnard, CA (US)

Correspondence Address: QUICKPATENTS, INC., 31877 DEL OBISPO, SUITE 202, SAN JUAN CAPISTRANO, CA, 92675, US

(21) Appl. No.: 11/307,971

(22) Filed: Mar. 1, 2006

Related U.S. Application Data
(60) Provisional application No. 60/660,814, filed on Mar. 4, 2005.
(60) Provisional application No. 60/723,077, filed on Sep. 28, 2005.

(51) Int. Cl. A23B 4/044

(52) U.S. Cl. 99/482

(57) ABSTRACT

A smoking apparatus that is placed into the cooking chamber of an outdoor grill is disclosed. A heating element is housed in an ash container, elevated with a riser and secured together with riser anchors. An arm contains and protects the heating element, resistance wires, and connected conductor wires is attached to a handle which facilitates portability and houses an indicator light, thermostatic controller, conductor wires, and an adjustment knob assembly. A power cord provides alternating current including an earth ground. The smoking wood is placed on the heating element and the ash container is positioned directly on the grill. The lid of the outdoor grill is closed, and rests directly upon the arm, with the handle and power cord extending outside of the outdoor grill.

### RELATED APPLICATIONS

The present application is a non-provisional application of U.S. provisional patent application 60/660814, filed Mar. 4, 2005, for INDIRECT HEAT COOKING APPARATUS, by Dave Whitmer, included by reference herein and for which benefit of the priority date is hereby claimed.

The present application is a non-provisional application of U.S. provisional patent application 60/723,077, filed Sep. 28, 2005, for METHOD AND APPARATUS FOR SMOKING FOOD, by Dave Whitmer, included by reference herein and for which benefit of the priority date is hereby claimed.

### FIELD OF THE INVENTION

The present invention relates to an outdoor smoking apparatus and, more particularly, to a portable smoking apparatus that is placed into the cooking chamber of an outdoor grill.

### BACKGROUND OF THE INVENTION

Since the beginning of recorded history, humans have cooked food over an open flame with wood as a heat source. As the food was cooked, the flavor of the wood was imparted or infused onto the food. Gas and electric outdoor grills offer the ability to cook food in a timely manner and ease of clean-up. The gas and electric fuel sources, however, do not produce a favorable smoke that is often preferred in the outdoor cooking of meats and fish in particular. Some enthusiasts prefer charcoal fired grills, some disadvantages are longer preparation of the heat source and clean-up.

Smoking wood has a tendency to flare-up when they are placed in close proximity to a heat source for an extended period of time. If a flare-up occurs, the wood burns too fast which can impart a bitter flavor upon the food and overcook or even char the food. A common method to minimize the chance of a flare-up would be to soak the wood in a container of water for up to an twenty-four hours and drain the excess water off the wood before using. This method can be messy and time consuming, and requires early preparation.

There are some widely accepted methods of smoking food in an outdoor grill with gas as the heat source. One method would be to use a commercially available smoker box, which typically consists of a vented rectangular metal box with a vented metal lid. The smoker box is filled with water-soaked smoking wood and the lid is placed upon the box. The smoker box is placed under the outdoor grill cooking grate and in close proximity to the heat source. A disadvantage of this method is, if the box is placed too close to the heat source the smoking wood will burn too fast imparting a bitter flavor onto the food. If the box is placed too far away from the heat source the smoking wood will burn at a less than desirable rate. Another disadvantage would be, to add additional smoking wood, the cook must first move or remove the food being cooked, lift a hot cooking grate, remove the hot lid of the smoker box, add more smoking wood, replace the smoker box lid and cooking grate. Yet another disadvantage is, after a short time of use, all outdoor grills have smoke and cooking residue collect onto the cooking grate. If the grate is hot or cold, this residue is very sticky and messy and can stain many things, including hands, clothes, or anything else that comes into contact with it.

Another method, when using gas as a heat source, would be to use a disposable aluminum foil pouch filled with water-soaked smoking wood with holes poked in the pouch for vents. The pouch is placed under the outdoor grill cooking grate and in close proximity to the heat source. A disadvantage of this method is, if the pouch is placed too close to the heat source the smoking wood will burn too fast imparting a bitter flavor onto the food. If the box is placed too far away from the heat source, the smoking wood will burn at a less than desired rate. Another disadvantage would be to add additional smoking wood, the cook must first move or remove the food being cooked, lift a hot cooking grate, open the hot pouch, add more smoking wood, then re-close the pouch and replace the cooking grate.

Another method to smoke food when using charcoal as the heat source requires soaking smoking wood in water and placing the wood under the cooking grate and onto or near the hot coals. A disadvantage to this method is the temperature of the heat source must be manually controlled by the venting of oxygen to the hot coals. If the heat becomes too hot the smoking wood will flare-up. Another disadvantage is the smoking wood must be thoroughly saturated with water, which could require soaking for up to 24 hours.

Most smoking devices are placed under the outdoor grill cooking grate, making it difficult to adjust the position of the device or adding additional wood once the cooking/smoking process has begun.

It is difficult to maintain a balance while using one heat source for cooking and burning smoking wood, the food can be undercooked and smoke flavor is properly imparted or the food can be cooked to a desired result and the smoke flavor is not imparted as desired.

In defiance of the maxim, “keep simple” certain inventors have developed more and more elaborate and complex devices for smoking food in an outdoor grill. Such devices can be found in specialty stores, mail order catalogs and on the internet and are described, for example, in U.S. Pat. No. 6,701,829, issued to FARROW for RAPID ANTI-FLARE SMOKER FOR GRILLS, and U.S. Pat. No. 4,190,677 issued to ROBBINS for METHOD FOR PRODUCING WOOD SMOKE ON A CHARCOAL GRILL.

Prior art smoking devices require placing the devices under the outdoor grill cooking grate. Liquid drippings produced during the cooking process will fall onto these devices and will collect residues. Over time the cooking residues and ash from the smoking wood will collect and build up. Placing smoking wood into many devices require lifting the cooking grate away from the outdoor grill container. Adding additional smoking wood requires lifting the cooking grate while it is hot, and can be dangerous. Some devices require a special tool to open the lid to add additional smoking wood. Most devices, once in use cannot be touched with an unprotected hand due to the extreme heat. Other devices are designed to be placed directly upon the mantle of a gas fired grill. Placing a smoking device on a mantle could damage the mantle. Other devices require wood flour that is not readably available at most specialty stores. Other devices use one heat source for cooking and burning smoking wood. Most devices do not use an independent heat source to burn the smoking wood.

It is therefore an object of the invention to provide an independent heat source for smoking food.

It is another object of the invention to provide a heating element for burning smoking wood slowly.

It is another object of the invention to provide a heat source temperature which minimizes smoking wood flare-ups.

It is another object of the invention to eliminate the need to soak smoking wood in water.

It is another object of the invention to provide the ability to add additional smoking wood throughout the whole cooking process.

It is another object of the invention to provide an independent heat source that burns smoking wood slowly while minimally influencing the overall temperature of the cooking chamber.

It is another object of the invention to provide the ability to pre-smoke the food, before igniting the cooking heat source.

It is another object of the invention to provide the ability to post-smoke the food, after the food has been cooked and the cooking heat source has been extinguished.

It is another object of the invention to provide an elevated heating source which allows burned ashes to fall into the bottom of a container.

It is another object of the invention to provide the ability to position the ash container in various places on the cooking grate.

It is another object of the invention to provide an arm with enough length to insure that the lid of the outdoor grill does not come into contact with the ash container.

It is another object of the invention to provide an arm with enough length to insure that the lid of the outdoor grill does not come into contact with the handle.

It is another object of the invention to provide hot coals as a alternate independent heat source for burning smoking wood slowly.

### SUMMARY OF THE INVENTION

In accordance with the present invention, there is provided a smoking apparatus that is placed into the cooking chamber of an outdoor grill which is both functional and simple. A heating element is housed in an ash container, elevated with a riser and secured together with riser anchors. An arm protects the heating element, resistance wires, and connected conductor wires when the lid of the outdoor grill is lowered. The arm is attached to a grip which allows for portability of the device and houses an indicator light, thermostatic controller, conductor wires, and an adjustment knob assembly. A power cord provides alternating current including an earth ground. The smoking wood is placed on the heating element and the ash container is positioned directly on the outdoor grill cooking grate. Current is applied to the heating element, the smoking wood begins to slowly burn. The lid of the outdoor grill is closed, and rests directly upon the arm, with the handle and power cord extending outside of the outdoor grill.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a smoking apparatus in accordance with the invention;

FIG. 2 is a side view, partially cut-away, of the smoking apparatus of FIG. 1;

FIG. 3 is a top view of an alternate embodiment of the smoking apparatus;

FIG. 4 is a cross-sectional view of the alternate embodiment of the smoking apparatus, taken generally along lines 4-4 of FIG. 3; and

FIG. 5 is a perspective view of the invention, illustrating the smoking apparatus as used with an outdoor grill.

For purposes of clarity and brevity, like elements and components will bear the same designations and numbering throughout the Figures.

### DESCRIPTION OF THE PREFERRED EMBODIMENT

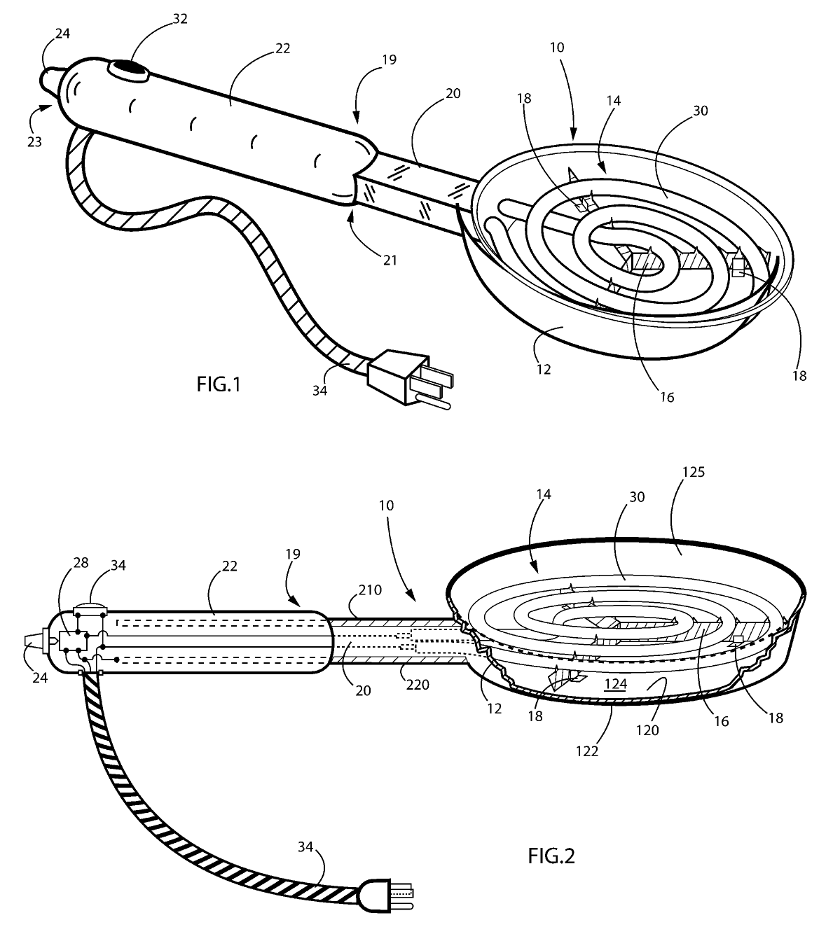

The apparatus of this invention is referred to generally in FIGS. 1-5 by the reference number 10 and is intended to provide a smoking apparatus 10 for cooking on an outdoor grill 50. It should be understood that the smoking apparatus 10 may be used to smoke many different types of food stuffs (not shown).

FIG. 1 is a perspective view of a smoking apparatus 10 and includes a multi-pronged riser 16 clamped to a heating means 14, such as a tubular, metal sheathed heating element 30. A riser anchor 18 consists of an angled bracket which is attached to the riser 16. Attached to the riser anchor 18 is an ash container 12, which consists of a generally flat bottom wall 120 (FIG. 2) with at least one vertically inclined side wall 125 extending upwards therefrom. The bottom wall 120 of the ash container 12 includes an upper surface 124 and a lower surface 122. The ash container 12 is preferably made from a rigid metal or metal alloy that can withstand high temperatures associated with cooking on an open flame. Further, the ash container 12 may include an additional weighted section (not shown) having additional weights to discourage the ash container 12 from tipping.

A handle means 19 includes an elongated arm 20 rigidly connected at a first end 21 to the ash container 12, and an insulated grip 22 fixed to a second end 23 of the handle means 19. The elongated arm 20 includes a top surface 210 and a bottom surface 220, the bottom surface 220 being in coplanar alignment with the lower surface 122 of the ash container 12. Preferably, the arm 20 consisting of a flat bottom wall with vertically inclined side walls extending upwards from the bottom wall and a flat top wall, forming a hollow channel therein.

The insulated grip 22 consists of a tubular member constructed of a heat insulating material, rounded at one end. Preferably, a small circular indicator light 32 is mounted on top and near the rounded end of the insulated grip 22 at the second end 23 of the handle means 19. A thermostatic controller 28 is included that includes an adjustment knob assembly 24. Such an adjustment knob 24 is preferably of the type having a heat resistant, threaded sleeve, a threaded rod and a tapered cylindrical member. The adjustment knob assembly 24 is preferably located in the center of the rounded end of the insulated grip 22 at the second end 23 of the handle means 19 (FIG. 2). A power cord 34 consists of a length of an insulated, three wire conductor with a standard electrical plug having two flat blades and a round blade. The power cord 34 provides power to the thermostatic controller 28, which selectively switches the heating element and the indicator light 32 to the power source 35 (FIG. 5) to maintain the heating element 14 within a selected temperature range.

FIG. 2 is a side view of the smoking apparatus 10 of FIG. 1, showing the resistance wire 30 embedded in a tubular metal sheath surrounded by an electrical insulating material. The thermostatic controller 28 is housed in the insulated grip 22 at the second end 23 of the handle means 19.

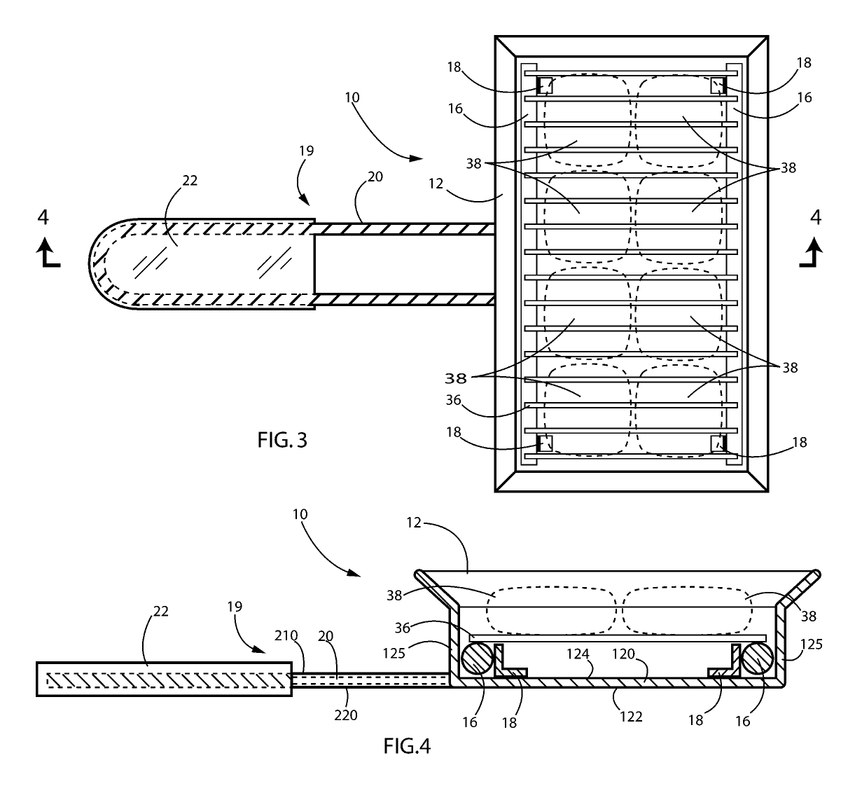

FIG. 3 is a top plan view of an alternate embodiment of the smoking apparatus 10, and includes a grate 36 consisting of two side risers 16, a plurality of traverse rods which are arranged generally in parallel, each end of which is positioned above and connected to one side riser 16. A plurality of riser anchors 18 is included, each of which comprises an angled bracket, and each of which are attached to one of the side risers 16. Attached to each riser anchor 18 is the upper surface 124 of the bottom wall 120 of the ash container 12. In this embodiment, the elongated arm 20 comprises a single rod curved at a center point, each end of which is attached to the ash container 12, preferably at the at least one side wall 125 thereof. A insulated grip 22 consisting of a heat insulating material and is connected to the elongated arm 20 at the second end 23 thereof.

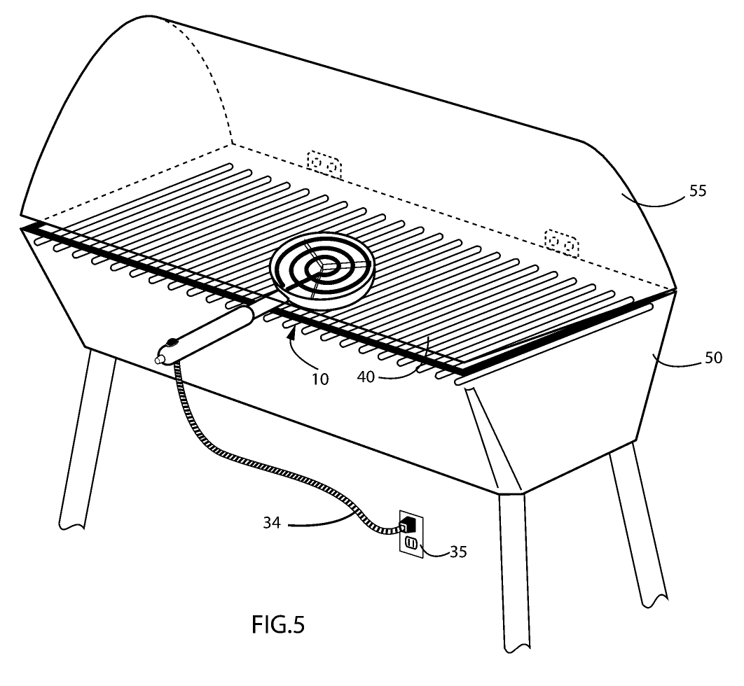

FIG. 4 is a cross-sectional view of the alternate embodiment of the smoking apparatus 10 of FIG. 3, and illustrates the manner in which the riser anchors 18 are attached to the ash container 12 and the side risers 16.

FIG. 5 is a perspective view of an outdoor grill 50 used with the smoking apparatus 10 of FIG. 1. The outdoor grill 50 is only one example of the various types of outdoor grills 50 available to which the smoking apparatus 10 of the invention may be employed. Therefore, the outdoor grill 50 is only described generally herein. Referring to FIG. 5, the outdoor grill 50 has a general box shaped configuration that is common to many outdoor grills 50 of prior art. Although the smoking apparatus 10 of the invention will be described using the box shaped outdoor grill 50 as an illustrative environment, it should be understood that the smoking apparatus 10 of the invention can be modified for its use in outdoor grills 50 of other shapes, for example outdoor grills 50 that have circular or rounded configurations. A source of heat such as gas, electricity, charcoal, or briquettes can be used. For illustrative proposes the source of heat in FIG. 5 is gas.

As shown in FIG. 1 each heat resistant riser 16 is securely clamped to the heating element 14 in a manner that does not deform the metal sheathing of the heating element 14. Each riser 16 is used for providing a stable base and elevating the heating element 14. The heating element 14 provides heat means, independent from the heat source of the grill 50, for slowly burning smoking wood. Additional smoking wood may be added onto the heating means at any time. The heating element 14 is preferably composed of a core of spiral wound resistance wire 30 and an insulating material within a tubular metal sheath, as is common in the art. The resistance wire 30, insulating material and sheath are thus combined into a structurally homogeneous unit which may be bent as desired into various shapes. The tubular shape can be formed to have a flat surface, if desired. The resistance wire 30 performs the function of providing heat.

Each heat resistant, riser anchor 18 is rigidly attached to the riser 16. The riser anchor 18 is rigidly attached to the ash container 12, such as through welding, heat resistant adhesives, heat stamping, or the like. Each riser anchor 18 is used for connecting the riser 16 to the ash container 12 to provide stability to the heating element 14. A stable, secured heating element 14 allows the smoking apparatus 10 to be turned upside down to dispose of ash after use of the smoking apparatus 10.

In use, the heat resistant ash container 12 is placed directly upon a cooking grate 40 of the outdoor grill 50. The side walls 125 of the ash container 12 extend above the top of the heating element 14, so as to contain burning wood and ashes (not shown) safely. The circumference of the ash container 12 provides adequate space for retaining a heating element 14 while containing burning wood and ashes. The ash container 12 is provided with an opening for which the ends of the heating element 14 can be extended through and into the handle means 19. For safety purposes the ash container 12 is weighted with an additional weighted section (not shown) to provide a counter balance for the arm 20, insulated grip 22, power cord 34, and associated electronics 28,32. The ash container 12 is weighted in a way as to prevent flipping of the apparatus over when it is placed on a surface with the arm 20, insulated grip 22, and power cord 34 extended outward. The heat resistant, arm 20 is rigidly attached to the ash container 12, such as by welding or other means. The insulated grip 22 is rigidly attached to the arm 20. The insulated grip 22 provides facilitates carrying of the smoking apparatus 10, even when the ash container and elongated arm 20 are too hot to touch directly. A closed end portion 230 of the insulated grip 22 provides an area to mount, a light 32, a thermostatic controller 28, and an adjustment knob assembly 24. Extending from a bottom portion of the insulated grip 22 is a power cord 34.

As shown in FIG. 2, each riser 16 elevates the heating element 14 to provide an area for ashes to fall and collect after the smoking wood has burned. The elevated heating element 14 provides a gap between the smoking wood and the ash container 12 to allow oxygen flow. The heating element 14 radiates heat in all directions which provides heat to burn smoking wood that might fall into the bottom of the ash container 12. The gaps between adjacent portions of the heating element 14 must be adequately sized to allow ashes to fall into the ash container 12 while minimizing the amount of unburned smoking wood falling into the ash container 12.

The heating element 14 extends through the ash container 12 and into the arm 20. The hollow, metal arm 20 provides enough space to accommodate the ends of the heating element 14, resistance wire 30, and connected conductor wires without coming into contact with the top, bottom, and vertical walls of the arm 20. All of the walls of the arm 20, except the top wall, are rigidly attached to the ash container 12. The arm 20 preferably includes a removable top wall to access the heating element 14, resistance wire 30, and connected conductor wires. The arm 20 protects the heating element 14, resistance wire 30, and the electrically connected conductor wires as a lid 55 of the outdoor grill 50 is rested directly upon the top wall surface 210 of the arm 20. As the edges of some outdoor grill covers 55 are manufactured at various widths, the length of the arm 20 is long enough to accommodate these various widths of grill covers 55. The height of the arm 20 is relatively short in order to keep the cover 55 close as possible to the lower section of the outdoor grill 50, thus minimizing the loss of heat or smoke through a gap created by the introduction of the smoking apparatus 10 between the cover 55 and the grill 50. Such a gap allows additional oxygen into a cooking chamber of the grill 50, assisting with the burning process. The bottom surface 220 of the arm 20, being coplanar with the lower surface 124 of the bottom wall 120 of the ash container 12 ensures that when the outdoor grill cover 55 is closed the smoking apparatus 10 will tilt only minimally, preventing or reducing spilling out of smoking wood or ash into the cooking chamber. The bottom surface 220 of the arm 20 extends into the insulated grip 22 to provide an electric ground contact.

When current is applied to the resistance wire 30 of the heating element 14 the light 32 is illuminated. When there is an absence of current to the resistance wire 30, the light 32 is likewise switched off. The neutral leg of the power cord 34 is electrically connected to the light 32. The output of the thermostatic controller 28 is electrically connected to the light 32. An insulated conductor is used for all electrical connections of the light 32. The thermostatic controller 28 is a temperature responsive device, based on thermal expansion for electrical switching purposes. The preferred thermostatic controller 28 is an auto cycle, bimetal assembly. The thermostatic controller 28 is designed for operation in a temperature range substantially above the normal ambient temperature, such as that of a hot plate, or similar high temperature appliances. The temperature control during all operating cycles, including the initial cycles, are consistent. The hot leg of the power cord 34 is electrically connected to the thermostatic controller 28. An output of the thermostatic controller 28 is electrically connected to a resistance wire 30. The thermostatic controller 28 is electrically connected to the electric ground of the power cord 34. An insulated conductor is used for all electrical connections of the thermostatic controller 28. The thermostatic controller 28 is rigidly attached to the insulated grip 22. The heat resistant adjustment knob assembly 24 consists of a threaded sleeve, a threaded rod and a tapered cylindrical member. The adjustment knob assembly 24 is rotationally attached to the insulated grip 22. The adjustment knob assembly 24 provides the mechanics for manually adjusting temperature of the heating means 14. The adjustment knob assembly 24 is turnably engaged to the thermostatic controller 28. The neutral leg of the power cord 34 is electrically connected to the resistance wire 30. The power cord 34 provides alternating current including an earth ground. The length of the power cord 34 extends beyond the ground level of the outdoor grill 50 in order to at least partially offset the weight of the three prong plug.

As shown in FIG. 3, an alternate embodiment of the invention utilizes hot coals 38 as the independent heating means 14 to slowly burn the smoking wood. Charcoal or briquettes can be used as the fuel. One method to ignite the charcoal or briquettes is to use a commercially available lighter fluid. Another method is to use a commercially available briquette chimney. Another method is to use pre-treated self igniting briquettes. The ash container 12 is sized to keep the hot coals 38 in close proximity to each other, thereby optimizing the heat retention of the coals. Controlling the temperature of the hot coals 38 is essential to avoid wood flare-ups. By keeping the hot coals 38, primarily in the hot cooking chamber, fresh oxygen flow is reduced. When the oxygen is limited to the hot coals 38, the smoking wood flare-ups are minimized.

Over time the hot coals 38 become starved of oxygen and become too cool for burning smoking wood. A method to expose the oxygen-starved coals to additional oxygen is to remove the smoking apparatus 10 from the cooking chamber periodically, allowing the coals to absorb additional oxygen, after which, reinserting the smoking apparatus 10 back into the cooking chamber. The arm 20 provides a gap between the outdoor grill lid 55 and the lower portion of the outdoor grill 50, which allows additional oxygen flow.

As shown in FIG. 4, the grate 36 is elevated by the risers 16, which provides an area for ashes to fall into and collect after the smoking wood and hot coals 38 are burned. The elevated grate 36 provides a gap between the hot coals 38 and the ash container 12 to allow increased oxygen flow. The lower portion of the arm 20 is coplaner with the lower surface 122 of the bottom wall 120 of the ash container 12, ensuring that when the outdoor grill lid 55 is closed the smoking apparatus 10 will tilt minimally, preventing or reducing spilling out of smoking wood or ash into the cooking chamber.

As shown in FIG. 5, the ash container 12 is placed directly upon an outdoor grill cooking grate 40. The arm 20 provides a gap between the outdoor grill lid 55 and the lower portion of the outdoor grill 50 which provides additional oxygen flow.

The ash container 12 in FIG. 1 is only one example of the various shapes available to which the smoking apparatus 10 of the invention may be employed. Additional shapes of ash containers which could be used are, but not limited to, oblong, square, or rectangle.

The heating element 14 in FIG. 1 is only one example of the various shapes available to which the smoking apparatus 10 of the invention may be employed. Additional shapes of heating elements which could be used are, but not limited to, oblong, square, or rectangle.

The thermostatic controller 28 in FIG. 1 is only one example of the various types of temperature controllers available to which the smoking apparatus 10 of the invention may be employed. Additional types of temperature controllers 28 which could be used are, but not limited to, fixed temperature or current-sensitive controllers. One advantage of the adjustable thermostatic controller 28 is that it provides the ability to burn different smoking woods at various rates. The thermostatic controller 28 preferably provides an adjustable set point temperature between the ranges of 375 and 500 degrees Fahrenheit of the heating element 14. The differential temperature can be up to 100 degrees Fahrenheit less than the set point temperature. It is common to soak smoking wood in water for up to one hour prior to burning, to avoid flare ups and to slow the rate of the wood burning process. With a set point temperature between 375 and 500 degrees Fahrenheit, it has been found that wood flare-ups are minimized. With proper temperature control, the need of soaking the smoking wood in water can be avoided.

An independent heat source provides the option of pre-smoking the food before igniting the cooking heat of the grill 50. Most commercially available outdoor grills 50 are provided with a warming rack. A method to pre-smoke the food stuffs to be cooked is to place the food upon an outdoor grill cooking grate 40 or the warming rack, add smoking wood to the apparatus 10, apply current to the heating element 14, close the lid 55 onto the arm 20, and smoke the food for a designated time period.

An independent heat source also provides the option of post-smoking the food. A method to post-smoke is to extinguish the cooking heat after the food is cooked, locate the food upon the outdoor grill cooking grate 40 or the warming rack, add additional smoking wood if needed to the apparatus 10, apply current to the heating element 14, close the lid 55 on the arm 20 and smoke the food for a designated time period.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A smoking apparatus for smoking food, comprising:
an ash containing means including a bottom wall and at least one side wall projecting upward from the bottom wall, the bottom wall having a lower surface and an upper surface;
a heating means, the heating means elevated above the bottom wall of the ash containing means by a riser rigidly connected thereto at a top end, the riser rigidly connected at a bottom end to the ash containing means;
a handle means comprising an elongated arm rigidly connected at a first end to the ash containing means, and a grip fixed to a second end of the handle means, the elongated arm including a top surface and a bottom surface, the bottom surface in coplanar alignment with the lower surface of the bottom wall of the ash containing means;
whereby a smoking fuel may be placed into the ash containing means onto the heating means to produce smoke, and whereby the ash containing means may be placed on a cooking grate of a grill with a grill cover of the grill resting on the top surface of the elongated arm to maintain the smoking apparatus in fixed relationship with the grill.

2. The smoking apparatus of claim 1 wherein the heating means is an electric heating element, the handle means further including insulated conductors for conducting electricity to the heating element from a power source.

3. The smoking apparatus of claim 2 further including an indicator light connected in parallel to the heating element for providing a visual indication of when the heating element is connected to the power source, the indicator light fixed to the handle means.

4. The smoking apparatus of claim 2 further including a thermostatic controller for selectively switching the heating element to the power source to maintain the heating element within a selected temperature range.

5. The smoking apparatus of claim 4 wherein the selected temperature range is between 350 and 550 degrees Fahrenheit.

6. The smoking apparatus of claim 4 wherein the selected temperature range is between 375 and 500 degrees Fahrenheit.

7. The smoking apparatus of claim 2 wherein the heating element is a spiral wound resistance wire.

8. The smoking apparatus of claim 7 wherein the resistance wire is substantially rectangular in cross-section.

9. The smoking apparatus of claim 7 wherein the resistance wire is substantially circular in cross-section.

10. The smoking apparatus of claim 1 wherein the ash containing means is substantially circular in plan view.

11. The smoking apparatus of claim 1 wherein the ash containing means is substantially rectangular in plan view.

12. The apparatus of claim 1 wherein the heating means is a plurality of hot coals.

13. The apparatus of claim 1 wherein the riser is rigidly connected to the top surface of the bottom wall of the ash containing means through a riser anchor means.

14. The apparatus of claim 1 wherein the ash containing means further includes an additional weighted section whereby the ash containing means is discouraged from tipping.
